(19) United States
(12) Patent Application Publication
(10) Pub. No.: US 2026/0079639 A1
(43) Pub. Date: Mar. 19, 2026

(54) MEMORY SYSTEM AND METHOD

(71) Applicant: Kioxia Corporation, Tokyo (JP)

(72) Inventors: Koji UEDA, Kawasaki Kanagawa (JP); Kiyotaka IWASAKI, Yokohama Kanagawa (JP); Takeshi MIURA, Yamato Kanagawa (JP)

(73) Assignee: Kioxia Corporation, Tokyo (JP)

(21) Appl. No.: 19/070,637

(22) Filed: Mar. 5, 2025

(30) Foreign Application Priority Data
Sep. 13, 2024 (JP) 2024-158737

(51) Int. Cl. G06F 3/06

(52) U.S. Cl. CPC G06F 3/0655; G06F 3/0604; G06F 3/0679

(57) ABSTRACT

According to the embodiment, two or more memory chips each include first storage areas. First memory chips among the two or more memory chips are connected to two or more channels. The memory controller executes a storage operation of storing first data on a group of second storage areas. Each of the second storage area is one of the first storage areas of each of the first memory chips. In the storage operation, the memory controller generates parity data corresponding to first data. The memory controller stores partial parity data that is part of the parity data in the second storage areas of each of the first memory chips. The memory controller stores both the partial parity data and partial first data that is part of the first data, in a second storage area of each of one or more second memory chips.

### CROSS-REFERENCE TO RELATED APPLICATIONS

This application is based upon and claims the benefit of priority from Japanese Patent Application No. 2024-158737, filed on Sep. 13, 2024, the entire contents of which are incorporated herein by reference.

### FIELD

Embodiments described herein relate generally to a memory system and a method.

### BACKGROUND

In a memory system such as a solid state drive (SSD), a memory controller is configured to execute, in parallel, the reading and writing of data from and to memory chips each connected to different channels, by controlling the channels in parallel. In addition, the memory controller performs error correction coding on a data block including pieces of data written in parallel in the memory chips. With this configuration, even if one memory chip among the memory chips on which data is written in parallel becomes inoperable, data stored in the one memory chip can be restored.

### BRIEF DESCRIPTION OF THE DRAWINGS

FIG. 1 is a diagram illustrating a configuration example of a memory system according to a first embodiment;

FIG. 2 is a schematic diagram illustrating an example of a configuration of a memory chip according to the first embodiment;

FIG. 3 is a diagram illustrating a circuit configuration of a physical block according to the first embodiment;

FIG. 4 is a diagram illustrating an example of data coding and a threshold voltage distribution according to the first embodiment;

FIG. 5 is a diagram illustrating an example of a configuration of a logical block according to the first embodiment;

FIG. 6 is a diagram illustrating an example of a configuration of a logical page according to the first embodiment;

FIG. 7 is a diagram f illustrating an example of data stored in a logical page according to the first embodiment;

FIG. 8 is a diagram illustrating an example of a data out command sequence according to a second embodiment;

FIG. 9 is a diagram illustrating an example of arrangement of parity clusters according to the second embodiment;

FIG. 10 is a diagram illustrating an example of arrangement of parity clusters according to a first modification; and

FIG. 11 is a diagram illustrating an example of arrangement of parity clusters according to a second modification.

### DETAILED DESCRIPTION

In general, according to the present embodiment, a memory system includes two or more channels, two or more memory chips, and a memory controller. Each of the two or more memory chips includes first storage areas. The two or more memory chips include first memory chips connected to the two or more channels. The number of the first memory chips is equal to the number of the two or more channels. The first memory chips include one or more second memory chips. The memory controller is electrically connected to the two or more memory chips via the two or more channels. The memory controller is configured to execute a storage operation of storing first data in a first group being a group of second storage areas. Each of the second storage area is one of the first storage areas of each of the first memory chips. The memory controller is configured to, in the storage operation, generate parity data corresponding to the first data by performing error correction coding on the first data, store partial parity data being part of the parity data in the second storage areas of each of the first memory chips, and store both the partial parity data and partial first data being part of the first data in the second storage area of each of the one or more second memory chips.

Hereinafter, a memory system and a method according to the embodiment will be described in detail with reference to the accompanying drawings. Note that the present disclosure is not limited by these embodiments.

### First Embodiment

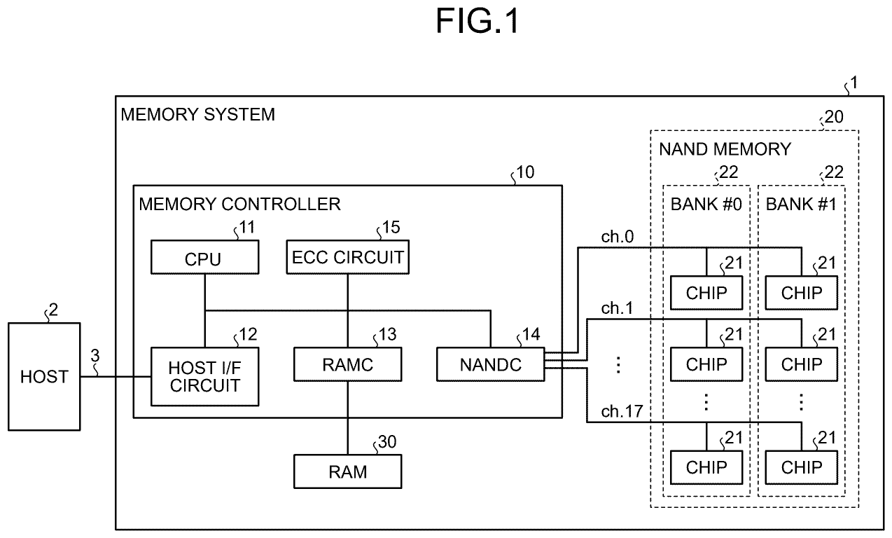

FIG. 1 is a diagram illustrating a configuration example of a memory system according to the first embodiment.

A memory system 1 can be connected to a host 2 via a communication path 3. The host 2 includes, for example, a central processing unit (CPU), a personal computer, a portable computer, a server, or a portable communication device. The memory system 1 stores data input from the host 2 in a nonvolatile manner.

The memory system 1 includes a memory controller 10, a NAND flash memory (NAND memory) 20, and a random access memory (RAM) 30. The NAND memory 20 is a nonvolatile memory used as a storage.

The RAM 30 is a volatile memory capable of operating at a higher speed than the NAND memory 20. The RAM 30 stores management information used by the memory controller 10 to control the NAND memory 20, and buffers data transferred between the host 2 and the NAND memory 20.

Optional type of memory can be applied as the RAM 30. For example, a dynamic random access memory (DRAM), a static random access memory (SRAM), or a combination thereof is applicable as the RAM 30. The RAM 30 may be built in the memory controller 10.

The memory controller 10 includes a central processing unit (CPU) 11, a host interface (host I/F) circuit 12, a RAM controller (RAMC) 13, a NAND controller (NANDC) 14, and an error correction code (ECC) circuit 15. The CPU 11, the host I/F circuit 12, the RAMC 13, the NANDC 14, and the ECC circuit 15 are electrically connected via a bus.

The memory controller 10 can be configured as a system-on-a-chip (SoC). The memory controller 10 can also be configured as a field-programmable gate array (FPGA) or an application specific integrated circuit (ASIC). Alternatively, the memory controller 10 can be configured to include a plurality of chips.

The host I/F circuit 12 controls a signal transferred via the communication path 3. The host I/F circuit 12 receives various commands from the host 2. The host I/F circuit 12 executes, for example, data transfer between the host 2 and the RAM 30. The RAMC 13 controls the RAM 30. The NANDC 14 controls the NAND memory 20. The NANDC 14 executes data transfer between the RAM 30 and the NAND memory 20, for example.

The CPU 11 is a processor that executes control of the entire memory controller 10. The CPU 11 executes the control based on a firmware program.

Part of or all the control executed by the CPU 11 may be executed by a dedicated hardware circuit. The function of each unit of the memory controller 10 may be implemented by the CPU 11 executing the firmware program.

The ECC circuit 15 executes error correction coding on data to be written to the NAND memory 20. The ECC circuit 15 performs decoding on data read from the NAND memory 20 to detect and correct an error that can be included in the read data. An example of the error correction coding by the ECC circuit 15 will be described later.

The NAND memory 20 includes two or more memory chips 21. In FIG. 1, each of the memory chips 21 is simply referred to as a chip 21 in order to avoid complication of the drawing. Each of the memory chips 21 is electrically connected to any one of channels (ch). The number of memory chips 21 connected to each of the channels may be common to all the channels, or may be different among the channels.

Each channel is constituted by a signal line group that conforms to a certain standard. The signal line group includes an I/O signal line and a control signal line group. The I/O signal line is a signal line for transferring data, an address, and a command. The bit width of the I/O signal line is not limited to one bit. The control signal line group is a group of a signal line that transfers a write enable (WE) signal, a signal line that transfers a read enable (RE) signal, a signal line that transfers a command latch enable (CLE) signal, a signal line that transfers an address latch enable (ALE) signal, a signal line that transfers a data strobe (DQS) signal, a signal line that transfers a write protect (WP) signal, and the like. Note that the configuration of each channel is not limited to this example.

The memory controller 10 is electrically connected to the memory chips 21 via the channels. The memory controller 10 can individually control each channel. The memory controller 10 can operate the memory chips 21 connected to different channels in parallel by simultaneously and individually controlling the channels. Thus, the memory controller 10 can simultaneously issue an access instruction to the memory chips 21 connected to different channels. Note that the access instruction includes a write instruction, a read instruction, and an erase instruction. The parallel operation of the memory chips 21 connected to different channels is referred to as channel parallel operation.

In the example illustrated in FIG. 1, the memory system 1 includes 18 channels (ch.0 to ch.17). Then, two memory chips 21 are connected to each channel. Therefore, the memory controller 10 can simultaneously control up to 18 memory chips 21 connected to different channels by the channel parallel operation.

Banks 22 are defined for the NAND memory 20. Each bank 22 includes plural (here, eighteen) memory chips 21 connected to different channels. Plural (here, two) memory chips 21 connected to one channel belong to different banks 22. Thus, the NAND memory 20 includes two banks 22 (Bank #0, Bank #1).

The memory controller 10 executes bank interleaving by using the two banks 22. The bank interleaving is a kind of parallel operations. In the bank interleaving, while plural (for example, eighteen) memory chips 21 belonging to one bank 22 are accessing data, the memory controller 10 issues an access instruction to plural (for example, eighteen) memory chips 21 belonging to another bank 22. As a result, the total time required for data transfer between the NAND memory 20 and the memory controller 10 is shortened. The parallel operation by bank interleaving is referred to as a bank parallel operation.

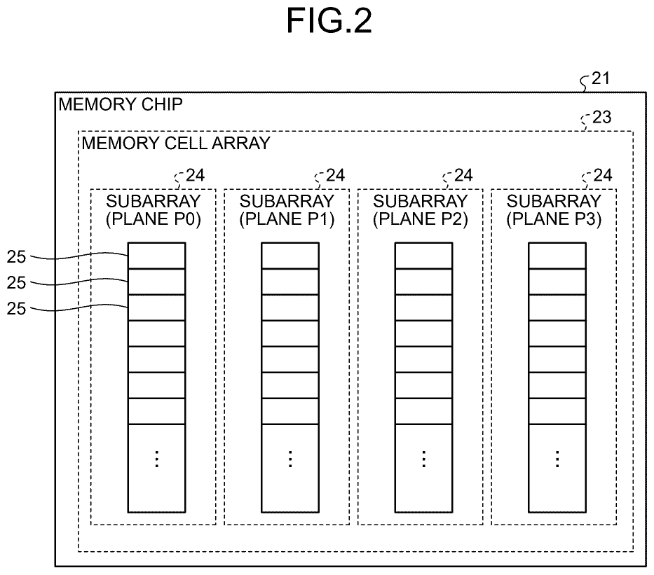

The memory chips 21 included in the NAND memory 20 have a common configuration. FIG. 2 is a schematic diagram illustrating an example of a configuration of the memory chip 21 according to the first embodiment.

The memory chip 21 includes a memory cell array 23. The memory cell array 23 is divided into subarrays 24. Each of the subarrays 24 constitutes one plane together with one of peripheral circuits (not illustrated) provided in the memory chip 21. Each peripheral circuit includes a row decoder, a column decoder, a page buffer, and the like. In the example illustrated in FIG. 2, the memory chip 21 includes four planes P0 to P3. Each of the four planes P0 to P3 includes one subarray 24.

Note that the number of planes included in the memory chip 21 is optional. The memory chip 21 may not include plural planes. When the memory chip 21 does not include the plural planes, the memory cell array 23 is not divided into the subarrays 24.

The memory chip 21 includes an independent peripheral circuit for each plane. Therefore, the memory chip 21 can access the subarray 24 of each plane in parallel. The access is a write operation, a read operation, and an erase operation. An operation of accessing the subarrays 24 of the planes in parallel is referred to as a plane-parallel operation.

Each subarray 24 contains physical blocks 25. The physical block 25 is a unit of an erase operation in the memory cell array 23.

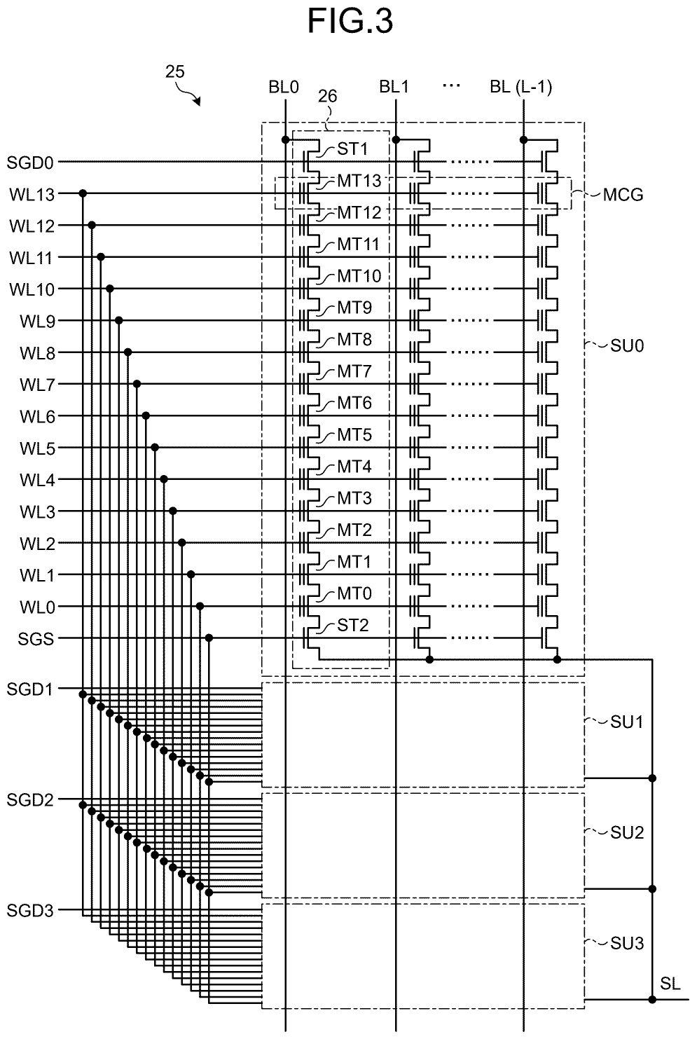

The physical blocks 25 have the same configuration. FIG. 3 is a diagram illustrating a circuit configuration of the physical block 25 according to the first embodiment.

The physical block 25 includes, for example, four string units SU0 to SU3. Each string unit SU includes a plurality of NAND strings 26.

Each of the NAND strings 26 includes, for example, fourteen (14) memory cell transistors MT (MT0 to MT13) and select transistors ST1 and ST2. The memory cell transistor MT includes a control gate and a charge storage layer, and stores data in a nonvolatile manner. The fourteen memory cell transistors MT (MT0 to MT13) are connected in series between the source of the select transistor ST1 and the drain of the select transistor ST2. Note that the memory cell transistor MT may be of a metal oxide nitride oxide silicon (MONOS) type using an insulating film for the charge storage layer, or may be of a floating gate (FG) type using a conductive film for the charge storage layer. The number of memory cell transistors MT in the NAND string 26 is not limited to fourteen.

The gates of the select transistors ST1 in the string units SU0 to SU3 are connected to select gate lines SGD0 to SGD3, respectively. On the other hand, the gates of the select transistors ST2 in the string units SU0 to SU3 are commonly connected to, for example, a select gate line SGS. The gates of the select transistors ST2 in the string units SU0 to SU3 may be connected to select gate lines SGS0 to SGS3 (not illustrated) different for each string unit SU. The control gates of the memory cell transistors MT0 to MT13 in the same physical block 25 are commonly connected to the word lines WL0 to WL13, respectively.

The drains of the select transistors ST1 of the NAND strings 26 in the string unit SU are connected to different bit lines BL (BL0 to BL (L−1), where L is a natural number of 2 or larger). In addition, the bit line BL commonly connects one NAND string 26 of each string unit SU among the physical blocks 25. The source of each select transistor ST2 is commonly connected to the source line SL.

The string unit SU is a set of NAND strings 26 connected to different bit lines BL and connected to the same select gate line SGD. The physical block 25 is a set of a plurality of string units SU sharing the word line WL. The subarray 24 is a set of a plurality of physical blocks 25 sharing the bit line BL.

As described above, the erase operation with respect to the subarray 24 is executed in units of physical blocks 25.

In addition, a write operation (specifically, a program operation) on the subarray 24 and a read operation (specifically, a sense operation) from the subarray 24 are collectively performed on the memory cell transistors MT connected to one word line WL in one string unit SU. Hereinafter, a group of memory cell transistors MT selected collectively during the program operation and the sense operation is referred to as a memory cell group MCG. Then, a group of storage areas of data of one bit stored in each of the memory cell transistors MT included in one memory cell group MCG is referred to as a physical page.

Each memory cell transistor MT may be configured to store a plurality of bits of data. For example, when each memory cell transistor MT can store n (n≥2) bits of data, the memory cell group MCG includes a storage area of n physical pages, and the storage capacity per memory cell group MCG is equal to the size of n physical pages. Here, as an example, a system in which 3-bit data is stored in each memory cell transistor MT will be described. According to this system, data of three physical pages is stored in each memory cell group MCG.

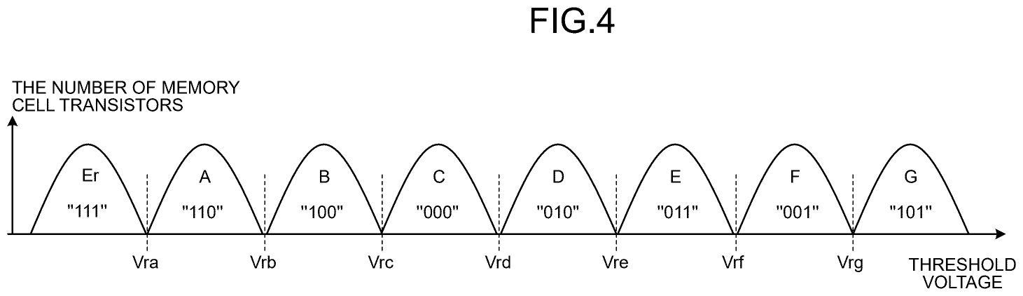

FIG. 4 is a diagram illustrating an example of data coding and a threshold voltage distribution according to the first embodiment. The horizontal axis indicates the threshold voltage of memory cell transistors MT. The eight lobes illustrated in FIG. 4 schematically represent the threshold voltage distribution. Each of the eight threshold voltage distributions is a threshold voltage region, and is also referred to as a state. The eight states correspond to 3-bit data. According to the example of the drawing, the Er state corresponds to data of “111”, the A state corresponds to data of “110”, the B state corresponds to data of “100”, the C state corresponds to data of “000”, the D state corresponds to data of “010”, the E state corresponds to data of “011”, the F state corresponds to data of “001”, and the G state corresponds to data of “101. The leading digit of each data is the most significant bit (MSB). In addition, the last digit of each data is the least significant bit (LSB). Note that the correspondence between the state and the data is not limited to this example.

The threshold voltage of each memory cell transistor MT is controlled to belong to any of the eight states. The threshold voltage of each memory cell transistor MT is set to the Er state by the erase operation, and is set to a state corresponding to data among the A state to the G state by the program operation.

In the sense operation, the state to which the threshold voltage of each memory cell transistor MT belongs is identified by comparing some read levels applied to the control gate via the word line WL with the threshold voltage. Then, data corresponding to the identified state is read.

A storage area in which data of the LSB is stored among storage areas of three physical pages included in one memory cell group MCG is referred to as a lower page. A storage area in which the MSB data is stored among the storage areas of the three physical pages is referred to as an upper page. A storage area in which data between the LSB and the MSB is stored among the storage areas of the three physical pages is referred to as a middle page. The classification of the lower page, the middle page, and the upper page is referred to as a page type.

The data coding applicable to the first embodiment is not limited to the example described above. The size of data stored in each memory cell transistor MT is not limited to three bits.

Note that each physical page includes a plurality of clusters. A logical address is given to each area (for example, sector) of a predetermined size in the logical address space provided to the host 2. A region of the predetermined size to which the logical address is given is referred to as a unit region. The cluster is a storage area in the NAND memory 20 corresponding to the unit region in the logical address space. The size of the unit region and the size of the cluster may be the same or different.

In addition, each physical page is mapped to a column address space. More specifically, column addresses of continuous values are given to the bit lines BL (for example, the bit lines BL0 to BL(L−1) in FIG. 3), and thereby the position in each physical page can be specified by the column address. The memory controller 10 designates a position of each cluster in each physical page by a column address. Hereinafter, a group of column addresses of consecutive values given to one physical page is referred to as a unit column address space. Note that the unit column address space is an example of the unit space. In addition, the memory cell transistor MT connected to the bit line BL designated by a certain column address is referred to as a memory cell transistor MT of the column address, and the column address designating the bit line BL connected to the certain memory cell transistor MT is referred to as a column address of the memory cell transistor MT.

Hereinafter, among the clusters included in a certain physical page, a cluster including the memory cell transistor MT of the head column address of the unit column address space is simply referred to as a head cluster. In addition, among the clusters included in a certain physical page, a cluster including the memory cell transistor MT of the column address at the end of the unit column address space is simply referred to as an end cluster. In addition, a cluster including the memory cell transistor MT of the column address which is subsequent to the maximum column address among the memory cell transistors MT included in the head cluster, is simply referred to as a second cluster from the head. The same applies to the Nth cluster from the head (N is an integer of 3 or larger).

As described above, the memory system 1 can perform a channel parallel operation, a bank parallel operation, and a plane parallel operation. The memory controller 10 manages a group of physical blocks 25 that can be accessed in parallel by any of the channel parallel operation, the bank parallel operation, and the plane parallel operation as one logical block. Then, the memory controller 10 performs the erase operation in units of logical blocks. The logical block is also called a super block.

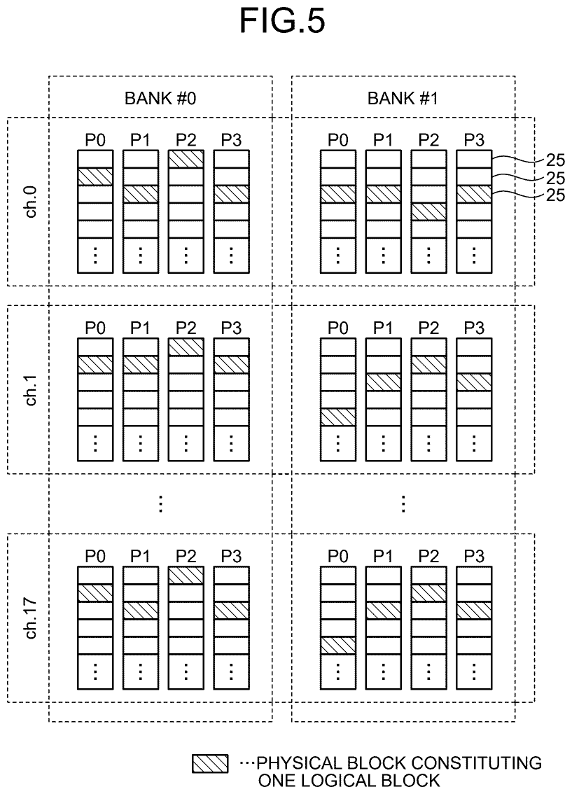

FIG. 5 is a diagram illustrating an example of a configuration of a logical block according to the first embodiment. As hatched with oblique lines in FIG. 5, one physical block 25 is selected for each combination of: the channel to which the memory chip 21 is connected; the bank 22 to which the memory chip 21 belongs; and the plane. Then, a group of the physical blocks 25, which are selected for each combination, is regarded as one logical block. The memory controller 10 can execute the erase operation in parallel on the group of physical blocks 25 constituting the logical block.

Hereinafter, a combination of the channel to which the memory chip 21 is connected, the bank 22 to which the memory chip 21 belongs, and the plane, will be referred to as a combination of the channel, the bank, and the plane.

For the group of physical blocks 25 constituting the logical block, the memory controller 10 can perform the write operation and the read operation in parallel by any of the channel parallel operation, the bank parallel operation, and the plane parallel operation. More specifically, a logical page is constituted by a group of one or more physical pages 27 collected from all the physical blocks 25 constituting one logical block. Then, the memory controller 10 can execute the write operation or the read operation in units of logical pages. The logical page is also referred to as a superpage.

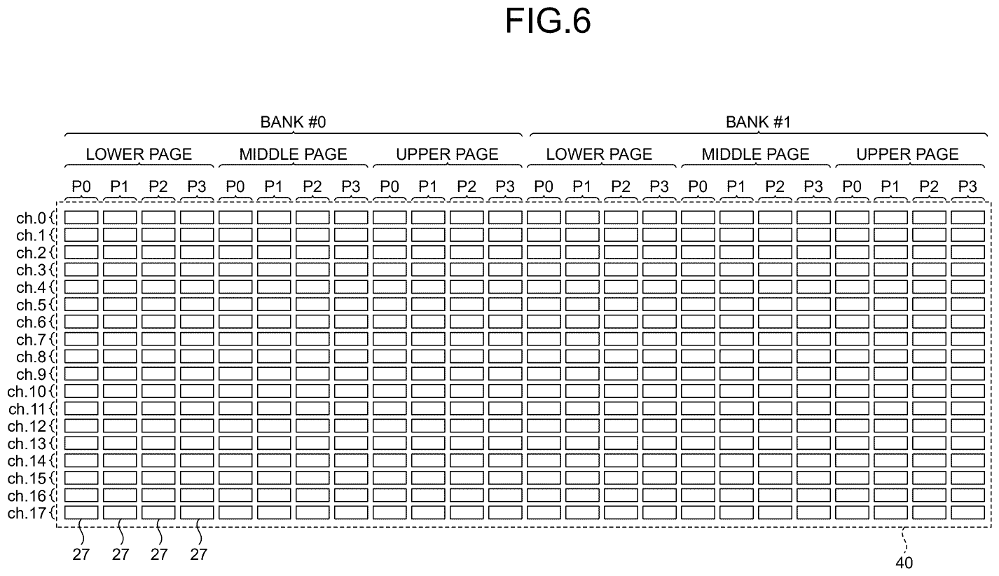

FIG. 6 is a diagram illustrating an example of a configuration of a logical page according to the first embodiment.

In the example illustrated in FIG. 6, three physical pages 27, that is, a physical page 27 of a lower page, a physical page 27 of a middle page, and a physical page 27 of an upper page, are selected for each combination of the channel, the bank, and the plane. Then, one logical page 40 is configured by a group of physical pages 27 obtained by collecting three physical pages 27 selected for each combination of the channel, the bank, and the plane, for all combinations of the channel, the bank, and the plane.

The memory controller 10 performs error correction coding on a group of data stored in one logical page 40 by the ECC circuit 15. Specifically, the memory controller 10 performs error correction coding on a data block that includes at least pieces of data stored in memory chips 21 connected to different channels, among a group of data stored in one logical page 40. Such error correction coding is referred to as channel crossing error correction coding.

Optional algorithm can be adopted as the algorithm of the channel crossing error correction coding. In one example, the ECC circuit 15 can perform encoding using Reed-Solomon (RS) coding as the channel crossing error correction coding.

The error correction code obtained by the channel crossing error correction coding is simply referred to as parity data. In addition, original data to which the channel crossing error correction coding is applied, namely, data transmitted from the host 2 is simply referred to as user data. The ECC circuit 15 may perform error correction coding different from the channel crossing error correction coding on data in advance before the channel crossing error correction coding is performed. Thus, the user data in the present disclosure may include, not only data transmitted from the host 2, but also an error correction code generated by the error correction coding different from the channel crossing error correction coding. The error correction coding different from the channel crossing error correction coding may be, for example, error correction coding in units of physical pages 27.

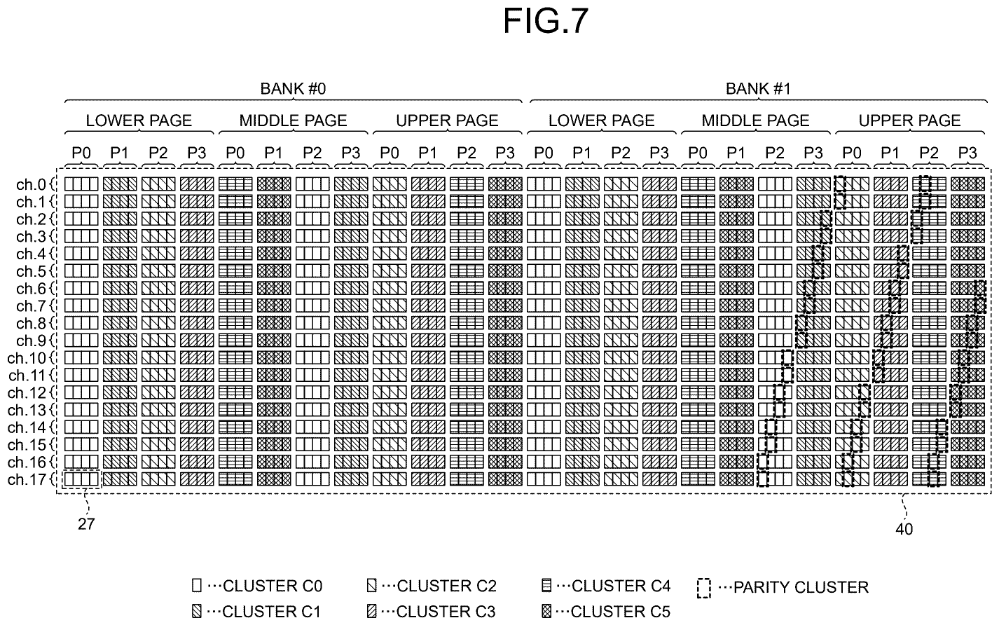

FIG. 7 is a diagram illustrating an example of data stored in a logical page 40 according to the first embodiment. In this drawing, the storage area constituting the logical page 40 is displayed in units of clusters. Note that one physical page 27 includes four clusters as an example. The order of arrangement of the four clusters in each physical page 27 corresponds to the order of column addresses. The number of clusters included in one physical page 27 is not limited to four.

In the example illustrated in FIG. 7, one logical page 40, which corresponds to a combination of eighteen (18) channels, two (2) banks, four (4) planes, three (3) physical pages per memory cell group MCG, and four (4) clusters per physical page, includes 1728 clusters (18×2×4×3×4=1728).

User data stored in one cluster is referred to as a cluster data piece. A cluster in which parity data is stored is referred to as a parity cluster.

A cluster included in the lower page of the plane P0 or the middle page of the plane P2 is referred to as a cluster C0. The group of clusters C0 includes eight parity clusters. The memory controller 10 performs the channel crossing error correction coding on the group of the cluster data pieces stored in the group of all the clusters C0 except the parity clusters, and generates the parity data for eight clusters. The memory controller 10 stores the generated parity data for eight clusters in the eight parity clusters included in the group of clusters C0.

A cluster included in the lower page of the plane P1 or the middle page of the plane P3 is referred to as a cluster C1. The group of clusters C1 includes eight parity clusters. The memory controller 10 performs the channel crossing error correction coding on the group of the cluster data pieces stored in the group of all the clusters C1 except the parity clusters, and generates the parity data for eight clusters. The memory controller 10 stores the generated parity data for eight clusters in the eight parity clusters included in the group of clusters C1.

A cluster included in the lower page of the plane P2 or the upper page of the plane P0 is referred to as a cluster C2. The group of clusters C2 includes eight parity clusters. The memory controller 10 performs the channel crossing error correction coding on the group of the cluster data pieces stored in the group of all the clusters C2 except the parity clusters, and generates the parity data for eight clusters. The memory controller 10 stores the generated parity data for eight clusters in the eight parity clusters included in the group of the clusters C2.

A cluster included in the lower page of the plane P3 or the upper page of the plane P1 is referred to as a cluster C3. The group of clusters C3 includes eight parity clusters. The memory controller 10 performs the channel crossing error correction coding on the group of the cluster data pieces stored in the group of all the clusters C3 except the parity clusters, and generates the parity data for eight clusters. The memory controller 10 stores the generated parity data for eight clusters in the eight parity clusters included in the group of the cluster C3.

A cluster included in the middle page of the plane P0 or the upper page of the plane P2 is referred to as a cluster C4. The group of clusters C4 includes eight parity clusters. The memory controller 10 performs the channel crossing error correction coding on the group of the cluster data pieces stored in the group of all the clusters C4 except the parity clusters, and generates the parity data for eight clusters. The memory controller 10 stores the generated parity data for eight clusters in the eight parity clusters included in the group of clusters C4.

A cluster included in the middle page of the plane P1 or the upper page of the plane P3 is referred to as a cluster C5. The group of clusters C5 includes eight parity clusters. The memory controller 10 performs the channel crossing error correction coding on the group of the cluster data pieces stored in the group of all the clusters C5 except the parity clusters, and generates the parity data for eight clusters. The memory controller 10 stores the generated parity data for eight clusters in the eight parity clusters included in the group of the cluster C5.

As described above, in the example illustrated in FIG. 7, a total of 48 clusters among 1728 clusters of one logical page 40 are used as parity clusters, and user data is stored in the remaining 1680 clusters.

The memory controller 10 may execute a read operation on the logical page 40 in response to a read command from the host 2. Such a read operation is referred to as a logical page read operation. In the logical page read operation, the memory controller 10 reads all the cluster data pieces stored in the logical page to be read in parallel in the 18 channels. In order to improve the response speed to the host 2, it is desirable to increase the efficiency of the logical page read operation, namely, to shorten the time required for the logical page read operation.

A technique compared with that of the embodiment will be described. A technique compared with that of the embodiment is denoted as a comparative example. According to the comparative example, 24 parity clusters among 48 parity clusters included in one logical page are arranged in one memory chip connected to one channel, and the remaining 24 parity clusters are arranged in one memory chip connected to another one channel. Thus, the 18 channels include 16 channels in which no parity cluster is arranged in any memory chip connected thereto, and two channels in which 24 parity clusters are arranged in one memory chip connected thereto.

The time required for reading the user data in one channel becomes longer according to the amount of user data written via the channel. In other words, the time required for reading the user data in one channel becomes longer as the amount of parity data written via the channel is smaller.

Moreover, the time required for the logical page read operation depends on the longest time among the times required for reading the user data executed via each of the 18 channels. Therefore, according to the comparative example, the time required for the logical page read operation is equal to the time required for reading the user data in the channel in which the parity cluster is not arranged in any memory chip connected thereto.

Hereinafter, the arrangement of a parity cluster in a memory chip connected to a channel will be referred to as distribution of the parity cluster to the channel.

In the embodiment, 48 parity clusters included in one logical page 40 are arranged such that the 48 parity clusters are distributed as uniformly as possible over 18 channels. As a result, as illustrated in FIG. 7, two or three parity clusters are distributed to any channel among the 18 channels.

The time required for reading the user data in a channel to which two parity clusters are distributed is longer than the time required for reading the user data in a channel to which three parity clusters are distributed, but is shorter than the time required for the user data in a channel to which no parity cluster is distributed. Therefore, according to the embodiment, the longest time required for reading the user data among the 18 channels is shortened as compared with the comparative example. As a result, the efficiency of the logical page read operation is improved as compared with the comparative example. Thus, the performance is higher than that of the comparative example.

According to the example illustrated in FIG. 7, for the channel ch.0 and the channel ch.1, the head cluster C2 of the upper page of the plane P0 of the memory chip 21 belonging to the bank #1 and the second cluster C4 from the head of the upper page of the plane P2 of the memory chip 21 belonging to the bank #1 are set as parity clusters.

For the channel ch.2 and the channel ch.3, the end cluster C1 of the middle page of the plane P3 of the memory chip 21 belonging to the bank #1 and the head cluster C4 of the upper page of the plane P2 of the memory chip 21 belonging to the bank #1 are set as parity clusters.

For the channel ch.4 and the channel ch.5, the third cluster C1 from the head of the middle page of the plane P3 of the memory chip 21 belonging to the bank #1 and the end cluster C3 of the upper page of the plane P1 of the memory chip 21 belonging to the bank #1 are set as parity clusters.

For the channel ch.6 and the channel ch.7, the second cluster C1 from the head of the middle page of the plane P3 of the memory chip 21 belonging to the bank #1, the third cluster C3 from the head of the upper page of the plane P1 of the memory chip 21 belonging to the bank #1, and the end cluster C5 of the upper page of the plane P3 of the memory chip 21 belonging to the bank #1 are set as parity clusters.

For the channel ch.8 and the channel ch.9, the head cluster C1 of the middle page of the plane P3 of the memory chip 21 belonging to the bank #1, the second cluster C3 from the head of the upper page of the plane P1 of the memory chip 21 belonging to the bank #1, and the third cluster C5 from the head of the upper page of the plane P3 of the memory chip 21 belonging to the bank #1 are set as parity clusters.

For the channel ch.10 and the channel ch.11, the end cluster C0 of the middle page of the plane P2 of the memory chip 21 belonging to the bank #1, the head cluster C3 of the upper page of the plane P1 of the memory chip 21 belonging to the bank #1, and the second cluster C5 from the head of the upper page of the plane P3 of the memory chip 21 belonging to the bank #1 are set as parity clusters.

For the channel ch.12 and the channel ch.13, the third cluster C0 from the head of the middle page of the plane P2 of the memory chip 21 belonging to the bank #1, the end cluster C2 of the upper page of the plane P0 of the memory chip 21 belonging to the bank #1, and the head cluster C5 of the upper page of the plane P3 of the memory chip 21 belonging to the bank #1 are set as parity clusters.

For the channel ch.14 and the channel ch.15, the second cluster C0 from the head of the middle page of the plane P2 of the memory chip 21 belonging to the bank #1, the third cluster C2 from the head of the upper page of the plane P0 of the memory chip 21 belonging to the bank #1, and the end cluster C4 of the upper page of the plane P2 of the memory chip 21 belonging to the bank #1 are set as parity clusters.

For the channel ch.16 and the channel ch.17, the head cluster C0 of the middle page of the plane P2 of the memory chip 21 belonging to the bank #1, the second cluster C2 from the head of the upper page of the plane P0 of the memory chip 21 belonging to the bank #1, and the third cluster C4 from the head of the plane P2 of the memory chip 21 belonging to the bank #1 are set as parity clusters.

Therefore, two parity clusters are distributed to each of the channels ch.0 to ch.5, and three parity clusters are distributed to each of the channels ch.6 to ch.17.

When storing data in the logical page 40 configured as described above, the memory controller 10 first prepares, for example, user data for the logical page 40 and parity data corresponding to the user data in the RAM 30. The memory controller 10 generates the parity data by performing the channel crossing error correction coding on the user data. Then, the memory controller 10 distributes the user data and the parity data through the 18 channels and transfers the data to the NAND memory 20, and writes the user data and the parity data to the logical page 40.

The transfer may not necessarily be started after all the preparation of the user data and the parity data for the logical page 40 is completed. The memory controller 10 may start the transfer at a timing when part of the data to be written, which includes the user data and the parity data, has been prepared in the RAM 30.

### Second Embodiment

The read operation for one physical page 27 includes a sense operation and a data out operation. As described above, the sense operation is an operation of reading data from one physical page 27 of one memory cell group MCG. Data read by the sense operation is stored in a page buffer included in the peripheral circuit. The data out operation is an operation of transferring some of or all pieces of data for one physical page 27 stored in the page buffer to the memory controller 10.

After causing the memory chip 21 to execute the sense operation, the memory controller 10 transfers a data out command sequence to the memory chip 21 to cause the memory chip 21 to execute the data out operation.

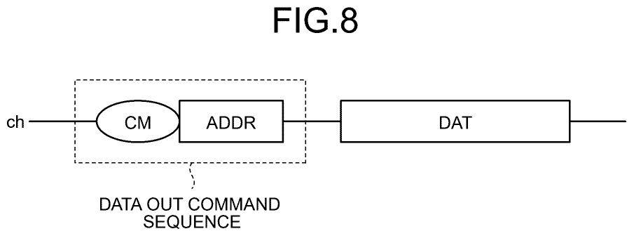

FIG. 8 is a diagram illustrating an example of a data out command sequence according to the second embodiment.

The data out command sequence includes a command identifier CM of the data out command and an address ADDR. The memory controller 10 transfers a pair of a row address and a column address to the memory chip 21 as the address ADDR. The memory controller 10 transfers the address ADDR including the value of a column address indicating the head position of a read target range in a physical page 27.

The memory chip 21 that has received the data out command sequence transfers, among the data of one physical page 27 stored in the page buffer by the sense operation, data DAT after the head position designated by the column address included in the address ADDR, to the memory controller 10.

In one example, the size of the data DAT output from the memory chip 21 is determined by the number of toggles of the RE signal toggled by the memory controller 10. When the memory controller 10 toggles the RE signal, the memory chip 21 generates the DQS signal based on the RE signal. The memory chip 21 outputs the data DAT in synchronization with the DQS signal. When the memory controller 10 ends the toggling of the RE signal, the memory chip 21 ends the output of the data DAT and DQS signals in response to the end of the toggling of the RE signal.

As described above, the memory controller 10 can acquire data stored in one range in a physical page 27 of which column addresses are continuous, by using the data out command sequence. Therefore, when it is desired to acquire data from two or more ranges in a physical page 27 of which column addresses are not consecutive, the memory controller 10 needs to issue a data out command sequence for each of the ranges.

Specifically, in a case where a certain cluster which is neither the head cluster nor the end cluster of a certain physical page 27 is set as a parity cluster, the memory controller 10 needs to issue a data out command sequence twice in order to read all the user data from the physical page 27 in the logical page read operation. That is, the memory controller 10 needs to issue a data out command sequence for obtaining the user data stored in one or more continuous clusters before the parity cluster in the physical page 27 and a data out command sequence for obtaining the user data stored in one or more continuous clusters after the parity cluster in the physical page 27.

The transfer of the data out command sequence requires a predetermined time. Therefore, even in the read operation of acquiring data from the same number of clusters in one physical page 27, the time required for the read operation increases as the number of issued data out command sequences increases.

In the second embodiment, one or more continuous clusters including the head cluster in the physical page 27 or one or more continuous clusters including the end cluster in the physical page 27 are set as a parity cluster, and a cluster in which user data is stored is set in only one continuous range that is not set as a parity cluster. Thus, by arranging the parity cluster close to the edge of the physical page 27, it is possible to store the user data in only one continuous range in the physical page 27.

Note that, as described above, the time required for the logical page read operation depends on the longest time required for reading the user data among the 18 channels. Then, as the number of distributed parity clusters is smaller in a channel (in other words, a channel in which the amount of parity data transferred when the data is stored in the logical page 40 is small), the time required for reading the user data is longer.

Therefore, for a channel having the smallest number of distributed parity clusters, the parity clusters are arranged close to the edge of the physical page 27. With this arrangement, the time required for reading the user data is shortened in a channel in which the time required for reading the user data is the longest. As a result, the time required for the logical page read operation is shortened, and the efficiency of the logical page read operation is improved.

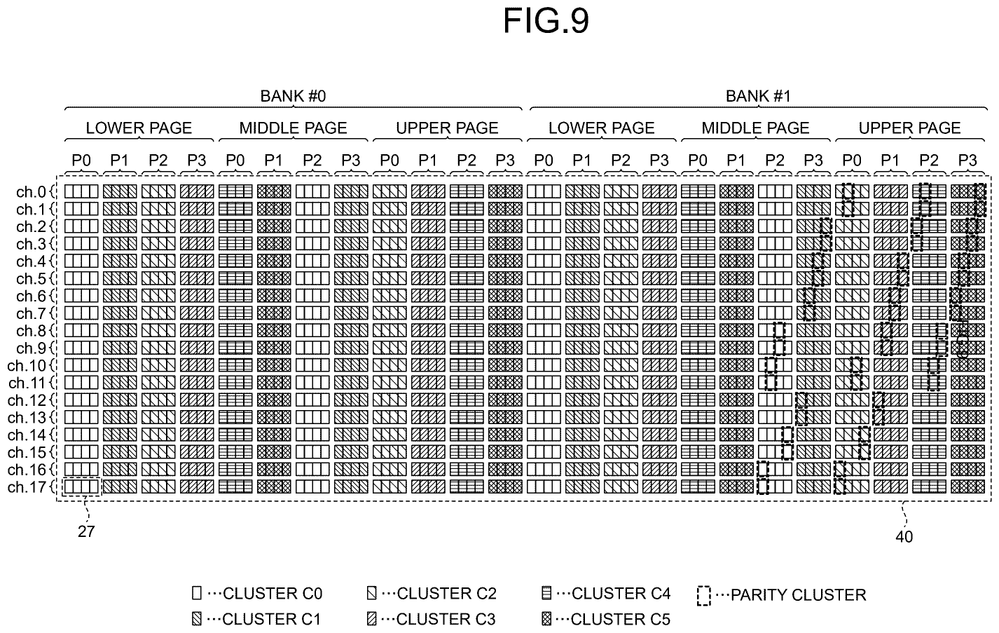

FIG. 9 is a diagram illustrating an example of arrangement of parity clusters according to the second embodiment.

Similarly to the example illustrated in FIG. 7, each of the group of clusters C0, the group of clusters C1, the group of clusters C2, the group of clusters C3, the group of clusters C4, and the group of clusters C5 includes eight parity clusters. Then, the 48 parity clusters are arranged so that the total of 48 parity clusters can be distributed as uniformly as possible in the 18 channels. As a result, two or three parity clusters are distributed to any channel among the 18 channels.

In the example illustrated in FIG. 9, three parity clusters are distributed to each of the channels ch.0 to ch.11, and two parity clusters are distributed to each of the channels ch.12 to ch.17.

For the channels ch.12 to ch.17 in each of which two parity clusters are distributed, the time required for reading the user data is longer than that for the channels ch.0 to ch.11 in each of which three parity clusters are distributed. For the channels ch.12 to ch.17 in each of which two parity clusters are distributed, each parity cluster is the head cluster or the end cluster of a physical page 27.

Specifically, for the channel ch.0 and the channel ch.1, the second cluster C2 from the head of the upper page of the plane P0 of the memory chip 21 belonging to the bank #1, the second cluster C4 from the head of the upper page of the plane P2 of the memory chip 21 belonging to the bank #1, and the end cluster C5 of the upper page of the plane P3 of the memory chip 21 belonging to the bank #1 are set as parity clusters.

On the other hand, for the channel ch.12 and the channel ch.13, the head cluster C1 of the middle page of the plane P3 of the memory chip 21 belonging to the bank #1 and the head cluster C3 of the upper page of the plane P1 of the memory chip 21 belonging to the bank #1 are set as parity clusters.

Therefore, for the channels ch.12 to ch.17, when acquiring user data from a physical page 27 provided with the parity cluster, the memory controller 10 can acquire all the user data by issuing a data out command sequence only once. In the channels ch.12 to ch.17 in each of which the two parity clusters are distributed, the time required for reading the user data is shortened. As a result, the time required for the logical page read operation is shortened. Therefore, the efficiency of the logical page read operation is improved.

### First Modification

In the first embodiment and the second embodiment, at most one cluster of one physical page 27 is set as a parity cluster. However, the number of clusters set as parity clusters in one physical page 27 may not be one at maximum.

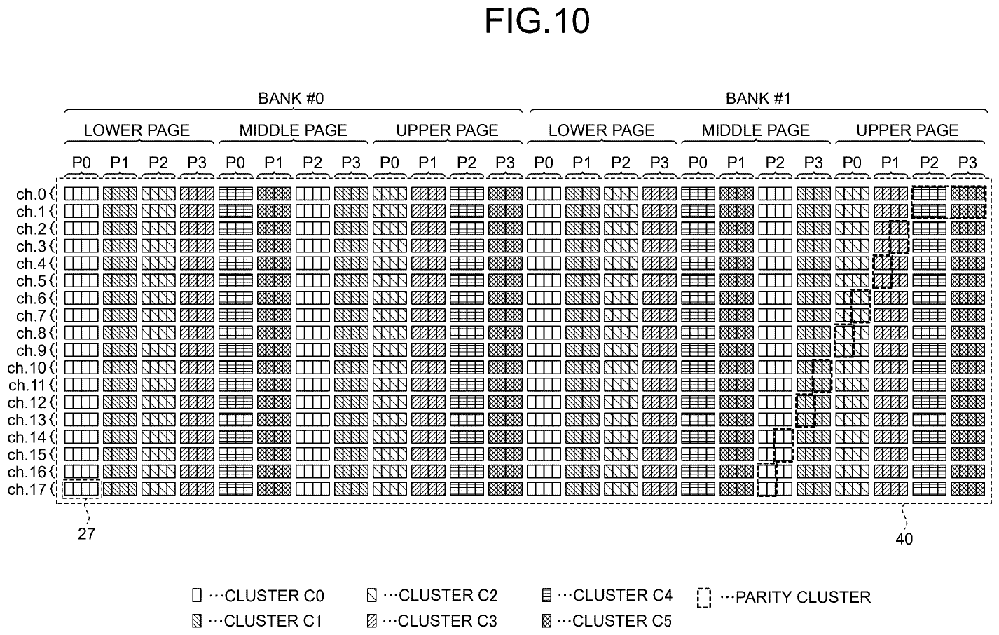

FIG. 10 is a diagram illustrating an example of arrangement of parity clusters according to the first modification.

Similarly to the example illustrated in FIG. 7, each of the group of clusters C0, the group of clusters C1, the group of clusters C2, the group of clusters C3, the group of clusters C4, and the group of clusters C5 includes eight parity clusters. A total of 48 parity clusters are distributed as described below.

For the channel ch.0 and the channel ch.1, all the clusters C4 and C5 of the upper pages of the plane P2 and the plane P3 of the memory chip 21 belonging to the bank #1 are set as parity clusters. Thus, in each of the channel ch.0 and the channel ch.1, four parity clusters are set for each of the two physical pages 27.

For the channel ch.2 and the channel ch.3, the latter two clusters C3 of the upper page of the plane P1 of the memory chip 21 belonging to the bank #1 are set as parity clusters.

For the channel ch.4 and the channel ch.5, the first two clusters C3 of the upper page of the plane P1 of the memory chip 21 belonging to the bank #1 are set as parity clusters.

For the channel ch.6 and the channel ch.7, the latter two clusters C2 of the upper page of the plane P0 of the memory chip 21 belonging to the bank #1 are set as parity clusters.

For the channel ch.8 and the channel ch.9, the first two clusters C2 of the upper page of the plane P0 of the memory chip 21 belonging to the bank #1 are set as parity clusters.

For the channel ch.10 and the channel ch.11, the latter two clusters C1 of the middle page of the plane P3 of the memory chip 21 belonging to the bank #1 are set as parity clusters.

For the channel ch.12 and the channel ch.13, the first two clusters C1 of the middle page of the plane P3 of the memory chip 21 belonging to the bank #1 are set as parity clusters.

For the channel ch.14 and the channel ch.15, the latter two clusters C0 of the middle page of the plane P2 of the memory chip 21 belonging to the bank #1 are set as parity clusters.

For the channel ch.16 and the channel ch.17, the first two clusters C0 of the middle page of the plane P2 of the memory chip 21 belonging to the bank #1 are set as parity clusters.

According to the above example, eight parity clusters are distributed to each of the channels ch.0 to ch.1, and two parity clusters are distributed to each of the channels ch.2 to ch.17. Therefore, in the channels ch.2 to ch.17 in each of which the two parity clusters are distributed, the time required for reading the user data is the longest. Further, in the channels ch.2 to ch.17, two parity clusters are arranged at the head or the end of a physical page 27. Thus, in the channels ch.2 to ch.17, when acquiring the user data from the physical page 27 provided with the parity clusters, the memory controller 10 can acquire all the user data by issuing a data out command sequence only once. The time required for reading the user data is shortened in the channels ch.12 to ch.17 in each of which the two parity clusters are distributed. Therefore, as in the second embodiment, the efficiency of the logical page read operation is improved.

### Second Modification

In the first embodiment, the second embodiment, and the first modification, since the total number of parity clusters is not equal to a multiple of the number of channels, the parity clusters cannot be arranged such that the number of parity clusters is uniform in all channels. When the total number of parity clusters is equal to a multiple of the number of channels, the parity clusters can be arranged such that the number of parity clusters is uniform in all channels.

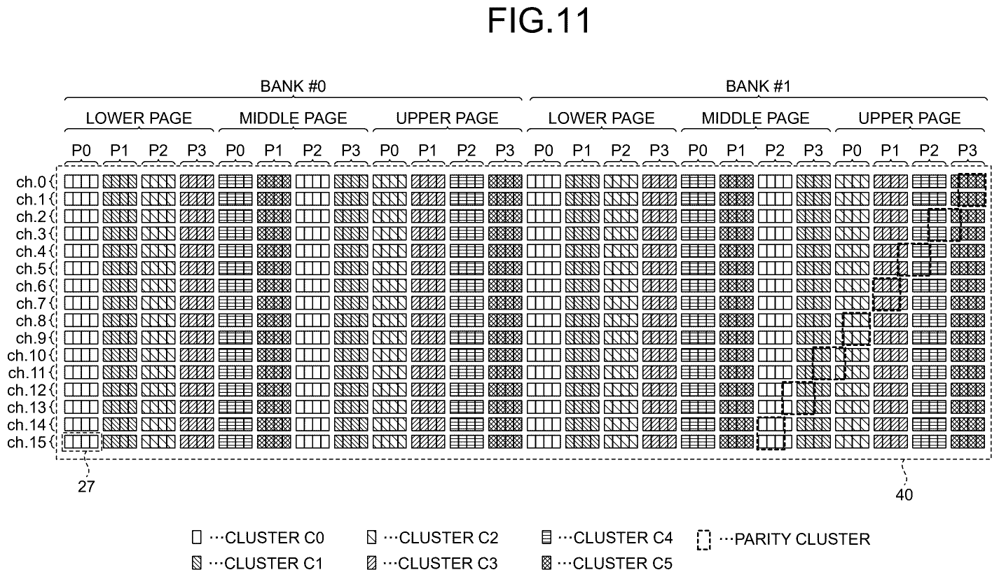

FIG. 11 is a diagram illustrating an example of arrangement of parity clusters according to the second modification.

The hardware configuration of the memory system 1 according to the second modification is different from that of the first embodiment, the second embodiment, and the first modification in that the memory system 1 includes 16 channels ch.0 to ch.15.

Similarly to the example illustrated in FIG. 7, each of the group of clusters C0, the group of clusters C1, the group of clusters C2, the group of clusters C3, the group of clusters C4, and the group of clusters C5 includes eight parity clusters.

The total number of parity clusters included in the logical page 40 is forty-eight (48). Thus, the total number of parity clusters included in the logical page 40 is three times the total number of channels included in the memory system 1. Therefore, three parity clusters are distributed to each channel.

Specifically, for the channel ch.0 and the channel ch.1, three clusters C5 from the second cluster C5 from the head to the end cluster C5 of the upper page of the plane P3 of the memory chip 21 belonging to the bank #1 are set as parity clusters.

For the channel ch.2 and the channel ch.3, the latter two clusters C4 of the upper page of the plane P2 of the memory chip 21 belonging to the bank #1 and the head cluster C5 of the upper page of the plane P3 of the memory chip 21 belonging to the bank #1 are set as parity clusters.

For the channel ch.4 and the channel ch.5, the end cluster C3 of the upper page of the plane P1 of the memory chip 21 belonging to the bank #1 and the first two clusters C4 of the upper page of the plane P2 of the memory chip 21 belonging to the bank #1 are set as parity clusters.

For the channel ch.6 and the channel ch.7, three clusters C3 from the head cluster C3 to the third cluster C3 from the head of the upper page of the plane P1 of the memory chip 21 belonging to the bank #1 are set as parity clusters.

For the channel ch.8 and the channel ch.9, three clusters C2 from the second cluster C2 from the head to the end cluster C2 of the upper page of the plane P0 of the memory chip 21 belonging to the bank #1 are set as parity clusters.

For the channel ch.10 and the channel ch.11, the latter two clusters C1 of the middle page of the plane P3 of the memory chip 21 belonging to the bank #1 and the head cluster C2 of the upper page of the plane P0 of the memory chip 21 belonging to the bank #1 are set as parity clusters.

For the channel ch.12 and the channel ch.13, the end cluster C0 of the middle page of the plane P2 of the memory chip 21 belonging to the bank #1 and the first two clusters C1 of the middle page of the plane P3 of the memory chip 21 belonging to the bank #1 are set as parity clusters.

For the channel ch.14 and the channel ch.15, three clusters C0 from the head cluster C0 to the third cluster C0 from the head of the middle page of the plane P2 of the memory chip 21 belonging to the bank #1 are set as parity clusters.

In this manner, three parity clusters are uniformly distributed to each channel.

Further, in all the physical pages 27 provided with the parity clusters, one or more parity clusters are arranged at the head or the end of the physical page 27. When the user data is acquired from the physical page 27 in which the parity cluster is provided in all the channels, the memory controller 10 can acquire all the user data by issuing a data out command sequence only once. Therefore, the time required for reading the user data from the physical page 27 provided with the parity cluster is shortened, and, as a result, the time required for the logical page read operation is shortened. Therefore, as in the second embodiment, the efficiency of the logical page read operation is improved.

In the first embodiment, the second embodiment, the first modification, and the second modification, three physical pages 27, namely, a lower page, a middle page, and an upper page are selected for each combination of the channel, the bank, and the plane. Then, a group of the physical pages 27 obtained by collecting the three physical pages 27 selected for each combination of the channel, the bank, and the plane for all the combinations is set as the logical page 40. The configuration of the logical page 40 is not limited to this example. At least as long as the logical page 40 is configured by a group of physical pages 27 selected from each of the memory chips 21 constituting the NAND memory 20, a configuration method thereof is optional.

As described above, in the first embodiment, the second embodiment, the first modification, and the second modification, when storing user data in a logical page 40 configured by a group of physical pages 27 selected from each of the memory chips 21 configuring the NAND memory 20, the memory controller 10 generates parity data corresponding to the user data by the channel crossing error correction coding for the user data. The logical page 40 is configured such that parity clusters are distributed to all the channels. Thus, the logical page 40 includes a physical page 27 provided with the parity cluster for each channel. Therefore, the memory controller 10 distributes the user data and the parity data to all the channels and transfers the user data and the parity data to the NAND memory 20.

Since the parity clusters are distributed to all the channels, the memory systems 1 of the first embodiment, the second embodiment, the first modification, and the second modification have the following features. As is clear from, for example, FIGS. 7, 9, 10, and 11, part of or all the physical page 27 provided with the parity cluster includes a physical page 27 in which part of the parity data and part of the user data are both stored.

In this way, since the parity clusters are distributed to all the channels, the time required for the logical page read operation is shortened as compared with the comparative example. Thus, the performance of the memory system 1 is higher than that of the comparative example.

In addition, according to the second embodiment, the first modification, and the second modification, the parity cluster is arranged close to the edge of a physical page 27 for a channel with the smallest number of distributed parity clusters among all the channels. In other words, among physical pages 27 in each of which data is stored via such a channel that transfers the smallest amount of the parity data when the data is stored in the logical page 40, in a physical page 27 in which part of the parity data and part of the user data are both stored, the part of the parity data is stored in a continuous range (referred to as a first range) at the head or the end of the physical page 27, and the part of the user data is stored in only one continuous range (referred to as a second range) different from the first range in the physical page 27.

Therefore, the time required to read the user data is shortened in a channel in which the time required to read the user data takes the longest time. As a result, the time required for the logical page read operation is shortened, and the efficiency of the logical page read operation is improved.

According to the first embodiment, the second embodiment, the first modification, and the second modification, each physical page 27 includes clusters. The memory controller 10 distributes parity data to the channels in units of clusters and stores the parity data in a group of physical pages 27 in which the parity cluster is provided in the logical pages 40.

According to the first embodiment, the second embodiment, the first modification, and the second modification, the logical page 40 includes three physical pages 27 selected for each plane. The method of configuring the logical page 40 is not limited to this example.

In the first embodiment, the second embodiment, the first modification, and the second modification, each physical page 27 included in the memory cell array 23 of each memory chip 21 is an example of a first storage area. Thus, each memory chip 21 can be considered to include a plurality of first storage areas.

Each memory chip 21 belonging to the bank #1 is an example of a first memory chip. Therefore, it can be considered that the number of first memory chips is equal to the number of channels.

A physical page 27 included in the first memory chip among all the physical pages 27 constituting a logical page 40 is an example of a second storage area. A group including the respective second storage areas of all the physical pages 27 constituting the logical page 40 is an example of a first group.

When storing the user data for the first group, the memory controller 10 stores part of the parity data in the second storage area of each first memory chip. In addition, the memory controller 10 stores part of the parity data and part of the user data in the second storage area of one or more second memory chips among the first memory chips.

A physical page 27 in which part of the parity data and part of the user data are both stored is an example of a third storage area.

A cluster is an example of a fourth storage area. The subarray 24 is an example of a subset.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
two or more channels;
two or more memory chips, each of the two or more memory chips including first storage areas, the two or more memory chips including first memory chips connected to the two or more channels, the number of the first memory chips being equal to the number of the two or more channels, the first memory chips including one or more second memory chips; and
a memory controller electrically connected to the two or more memory chips via the two or more channels, and configured to
execute a storage operation of storing first data in a first group being a group of second storage areas, each of the second storage areas being one of the first storage areas of each of the first memory chips, wherein
the memory controller is configured to, in the storage operation,
generate parity data corresponding to the first data by performing error correction coding on the first data;
store partial parity data being part of the parity data in the second storage area of each of the first memory chips; and
store both the partial parity data and partial first data being part of the first data in the second storage area of each of the one or more second memory chips.

2. The memory system according to claim 1, wherein
each of the first storage areas is mapped to a unit space configured by a group of addresses having consecutive values,
the second storage areas of the one or more second memory chips include a third storage area storing a first amount of the partial parity data, the first amount being the smallest amount among an amount of the partial parity data to be stored in each of the second storage areas of the one or more second memory chips, and
the memory controller is configured to:
store the partial parity data in a continuous first range at a head or an end of the unit space in the third storage area; and
store the partial first data only in one second range being different from the first range of the unit space and being continuous.

3. The memory system according to claim 2, wherein the memory controller is configured to:
read, by only one command sequence, the partial parity data from the first range of the third storage areal; and
read, by only another command sequence, the partial first data from the second range of the third storage area.

4. The memory system according to claim 1, wherein
each of the first storage areas includes fourth storage areas, and
the memory controller is configured to:
divide the parity data into the partial parity data in units of the fourth storage area; and
store the partial parity data in the second storage area of each of the first memory chips.

5. The memory system according to claim 4, wherein
the first memory chips include one or more third memory chip, and
the memory controller is configured to store the partial parity data in all the fourth storage areas included in the second storage area of at least one of the one or more third memory chips.

6. The memory system according to claim 1, wherein
the first storage areas of each of the two or more memory chips are divided into subsets, and
the first group includes the first storage area of each of the subsets as the second storage area.

7. The memory system according to claim 1, wherein
the same amount of the partial parity data is stored in the second storage area of each of the first memory chips.

8. A memory system comprising:
two or more channels;
two or more memory chips, each of the two or more memory chips including physical pages, the two or more memory chips including first memory chips connected to the two or more channels, the number of the first memory chips being equal to the number of the two or more channels, the first memory chips including one or more second memory chips; and
a memory controller electrically connected to the two or more memory chips via the two or more channels, and configured to
execute a storage operation of storing first data in a logical page, the logical page including first physical pages, each of the first physical pages being one of the physical pages of each of the first memory chips, wherein
the memory controller is configured to, in the storage operation,
generate parity data corresponding to the first data by performing error correction coding on the first data;
store partial parity data being part of the parity data in the first physical page of each of the first memory chips; and
store both the partial parity data and partial first data being part of the first data in the first physical page of each of the one or more second memory chips.

9. The memory system according to claim 8, wherein
each of the physical pages is mapped to a unit column address space configured by a group of column addresses having consecutive values,
the first physical pages of the one or more second memory chips include a second physical page storing a first amount of the partial parity data, the first amount being the smallest amount among an amount of the partial parity data to be stored in each of the first physical pages of the one or more second memory chips, and
the memory controller is configured to:
store the partial parity data in a continuous first range at a head or an end of the unit column address space in the second physical page, and
store the partial first data only in one second range being different from the first range of the unit column address space and being continuous.

10. The memory system according to claim 9, wherein the memory controller is configured to:
read, by only one command sequence, the partial parity data from the first range of the second physical page; and
read, by only another command sequence, the partial first data from the second range of the second physical page.

11. The memory system according to claim 8, wherein
each of the physical pages includes clusters, and
the memory controller is configured to:
divide the parity data into the partial parity data in units of the clusters; and
store the partial parity data in the first physical page of each of the first memory chips.

12. The memory system according to claim 11, wherein
the first memory chips include one or more third memory chip, and
the memory controller is configured to store the partial parity data in all the clusters included in the first physical page of at least one of the one or more third memory chips.

13. The memory system according to claim 8, wherein
the physical pages of each of the two or more memory chips are divided into subarrays, and
the logical page includes the physical page of each of the subarrays as the first physical page.

14. The memory system according to claim 8, wherein
the same amount of the partial parity data is stored in the first physical page of each of the first memory chips.

15. A method of controlling two or more memory chips via two or more channels, each of the two or more memory chips including first storage areas, the two or more memory chips including first memory chips connected to the two or more channels, the number of the first memory chips being equal to the number of the two or more channels, the first memory chips including one or more second memory chips, the method comprising:
executing a storage operation of storing first data in a first group being a group of second storage areas, each of the second storage areas being one of the first storage areas of each of the first memory chips; and
executing processing in the storage operation, the processing including:
generating parity data corresponding to the first data by performing error correction coding on the first data;
storing partial parity data being part of the parity data in the second storage area of each of the first memory chips; and
storing both the partial parity data and partial first data being part of the first data in the second storage area of each of the one or more second memory chips.

16. The method according to claim 15, wherein
each of the first storage areas is mapped to a unit space configured by a group of addresses having consecutive values,
the second storage areas of the one or more second memory chips include a third storage area storing a first amount of the partial parity data, the first amount being the smallest amount among an amount of the partial parity data to be stored in each of the second storage areas of the one or more second memory chips, and
the method further comprises:
storing the partial parity data in a continuous first range at a head or an end of the unit space in the third storage area; and
storing the partial first data only in one second range being different from the first range of the unit space and being continuous.

17. The method according to claim 16, further comprising
reading, by only one command sequence, the partial parity data from the first range of the third storage area, and
reading, by only another command sequence, the partial first data from the second range of the third storage area.

18. The method according to claim 15, wherein
each of the first storage areas includes fourth storage areas, and
the method further comprises:
dividing the parity data into the partial parity data in units of the fourth storage area; and
storing the partial parity data in the second storage area of each of the first memory chips.

19. The method according to claim 18, wherein
the first memory chips include one or more third memory chip, and the method further comprises:
storing the partial parity data in all the fourth storage areas included in the second storage area of at least one of the one or more third memory chips.

20. The method according to claim 15, wherein
the first storage areas of each of the two or more memory chips are divided into subsets, and
the first group includes the first storage area of each of the subsets as the second storage area.
